(19) United States
(12) Patent Application Publication
(10) Pub. No.: US 2010/0201069 A1
(43) Pub. Date: Aug. 12, 2010

(54) MULTIPLE OBJECTS LOCATION APPARATUSES AND SYSTEMS, AND LOCATION METHODS AND ERROR ADJUSTMENT METHODS THEREOF

(75) Inventor: Ar Fu Lam, Hsinchu City (TW)

Correspondence Address: QUINTERO LAW OFFICE, PC, 615 Hampton Dr, Suite A202, Venice, CA, 90291, US

(73) Assignee: INDUSTRIAL TECHNOLOGY RESEARCH INSTITUTE, Hsinchu (TW)

(21) Appl. No.: 12/612,519

(22) Filed: Nov. 4, 2009

(30) Foreign Application Priority Data
Feb. 12, 2009 (TW) 098104428

(51) Int. Cl. A63F 3/00; G06K 7/01

(52) U.S. Cl. 273/237; 340/10.1

(57) ABSTRACT

Location system and location method are provided to identify and measure the positions of multiple objects located on a plane, such as a game board. Each of the objects includes means for transmitting an identification signal. The location system includes at least two sensors and a processor. In a preferred embodiment, the system includes at least two sensors positioned at the peripheral of a plane such as the adjacent corners of a square or rectangular game board for receiving a first and a second identification signals sent by a first object and a second object respectively positioned on the game board. The processor is coupled to the two sensors for identifying and determining the positions of the objects according to the signal strengths and identities of the first and second signals received.

### CROSS REFERENCE TO RELATED APPLICATIONS

This Application claims priority of Taiwan Patent Application No. 098104428, filed on Feb. 12, 2009, the entirety of which is incorporated by reference herein.

### BACKGROUND OF THE INVENTION

1. Field of the Invention

The disclosure relates generally to location apparatuses and location methods and error adjustment methods using the same, and, more particularly to location apparatuses and location methods and error adjustment methods using the same applied in determination of positions of multiple objects on a specific area, such as a square board or a rectangular board.

2. Description of the Related Art

RFID (Radio Frequency Identification) is so-called a wireless radio frequency identification system which is developed to overcome the drawback of the touchable systems. RFID can also be served as a chip built-in a wireless technology in which the chip may store a serial of information, such as a product type, a manufacture date, a position and so on, and RFID is typically applied in sensing products such as sensing cards, sensing ID cards or sensing toys. A small RFID tag is applied to or incorporated into such products such that a RFID reader can identify the RFID tag via a wireless connection, such as transmit and receive data, pass energy wirelessly and then reply the identified data to the system via a radio frequency signal for the purpose of identification and tracking using radio waves. As the developments of the RFID based technologies growth, current RFID technology may support identification for multiple RFID tags by some methods such as a time delay method or a frequency drift method.

However, due to the high cost and low identification accuracy of the RFID reader and inconsistent problems between the multi-tag positions and corresponding tag data when multiple tags have been applied, RFID is typically for identification application only. For some specific applications (e.g. for electronic game boards), to successfully perform a game, multiple objects on the board have to be located and identified instantaneously such that RFID applied in applications for games and toys that require precisely locating become difficult. Currently, no effective location method for RFID applications has been proposed.

It is therefore important, to develop location system and method for multi-tags that may provide, in addition to the identification function, precisely position information for each tag.

### BRIEF SUMMARY OF THE INVENTION

Location systems and methods for identifying and locating multiple objects within a specific region are provided.

In an embodiment of a location method for determining positions of a plurality of objects located on a game board, wherein each of said objects comprises means for transmitting an identification signal wirelessly, a first, a second and a third identification signals sent by a first object, a second object and a third object respectively are first received, each of the identification signals received by each sensor having a signal strength. Next, a position of the object on the game board is determined according to the signal strengths of the identification signals received by at least a first, a second and a third sensors. The first, second and third sensors are separately positioned at different fixed positions on the game board.

Another embodiment of a location system configured on a rectangular board or a square board for determining positions of a plurality of objects located on the rectangular board or the square board, wherein each of said objects is capable of transmitting an identification signal including an identification code wirelessly. The system comprises at least two sensors and a processing unit. The two sensors are separately positioned at the adjacent corners of the square board or rectangular board for separately receiving an identification signal from one of the objects, each of the identification signals received by each sensor having signal strength. The processing unit is coupled to the two sensors for determining a position of the object on the board according to the signal strengths of the identification signals received by the two sensors.

For mass production, the position of each sensor and the signal strength measured may have different levels of deviation errors, and thus another embodiment further provides an error calibration method for use in a location apparatus for adjusting or compensating the position measurement values of a plurality of objects located on a game board, wherein each of objects is capable of transmitting an identification signal wirelessly and the location apparatus at least comprises first, second and third sensors. The method comprises separately receiving a first, a second and a third identification signals by the first, second and third sensors. Then, at least one first and one second signal strengths or position measurement values are obtained according to the received signal strengths of the first, the second and the third identification signals. Thereafter, an automatic error correction operation corresponding to the first and the second signal strengths or position measurement values is performed to determine a more precisely position for the object on the game board, wherein each of the first, second and third sensors is separately positioned at different fixed positions on the game board. Traditionally, the signal strength is represented by a volt unit and the measurement value is represented by a length unit such as inch or centimeter. If the position of the object is used for a game software without providing any measurement unit for user reference, the position of the object may also be directly represented by the unit of the signal strength.

Another embodiment of a location system configured on a game board for determining positions of a plurality of objects located on the board, wherein each of said objects is capable of transmitting an identification signal including an identification code wirelessly for identification. The system comprises a transmission device, at least three receiving devices and at least one of the following characteristics: (1) the game board comprises a calibration point positioned at a specific known position for providing a calibration signal; (2) a common energizer and a plurality of receiving antennas, wherein each of the receiving devices has a corresponding receiving antenna among the receiving antennas and the common energizer further transmits a power signal to the objects for providing energy such that the object transmits a replied identification signal corresponding thereto and each of the receiving devices receives the replied identification signal via the corresponding receiving antenna; (3) each of the objects comprises a voltage regulator such that each object transmits an identification signal with a fixed voltage level; and (4) the location system ensures that a distance between each two adjacent objects of the objects matches to a minimum resolution requirement utilizing a predetermined condition, wherein the predetermined condition represents that the minimum distance 2R between each two adjacent objects is larger than or equal to a smallest distance 2L, wherein L represents a calculated or measured maximum error distance that may happens.

Location methods and systems for determining positions of a plurality of objects located on a board may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a game system of the invention;

FIG. 2 is a schematic diagram illustrating an embodiment of a location apparatus of the invention;

FIGS. 3A and 3B are schematic diagrams illustrating embodiments of game boards of the invention;

FIG. 4A is a schematic diagram illustrating an embodiment of a locating result for two sensors that do not being positioned at the corners of the invention;

FIG. 4B is a schematic diagram illustrating an embodiment of a locating result for two sensors positioned at the corners of the invention;

FIG. 4C is a schematic diagram illustrating an embodiment of a locating result for two sensors positioned at the corners and error occurred of the invention;

FIG. 5 is a flowchart of an embodiment of a location method of the invention;

FIG. 6A is a schematic diagram illustrating another embodiment of a location apparatus of the invention;

FIG. 6B is a schematic diagram illustrating an embodiment of an object circuit of the invention;

FIG. 6C is a schematic diagram illustrating an embodiment of a sensor circuit of the invention;

FIG. 7A is a schematic diagram illustrating an embodiment of an object configuration of the invention;

FIGS. 7B and 7C are schematic diagrams illustrating embodiments of object distances of the invention;

FIGS. 8A-8D are schematic diagrams illustrating embodiments of locating results for four sensors positioned at the corners of the invention;

FIG. 9 is a flowchart of an embodiment of an error calibration method of the invention;

FIGS. 10A and 10B are schematic diagrams illustrating embodiments of auto tolerance calibration results calibrated by using a calibration point of the invention;

FIG. 11A is a schematic diagram illustrating an embodiment of a characteristic curve measurement method of the invention; and

FIG. 11B is a schematic diagram illustrating an embodiment of a characteristic curve measured by using the characteristic curve measurement method of FIG. 11A.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

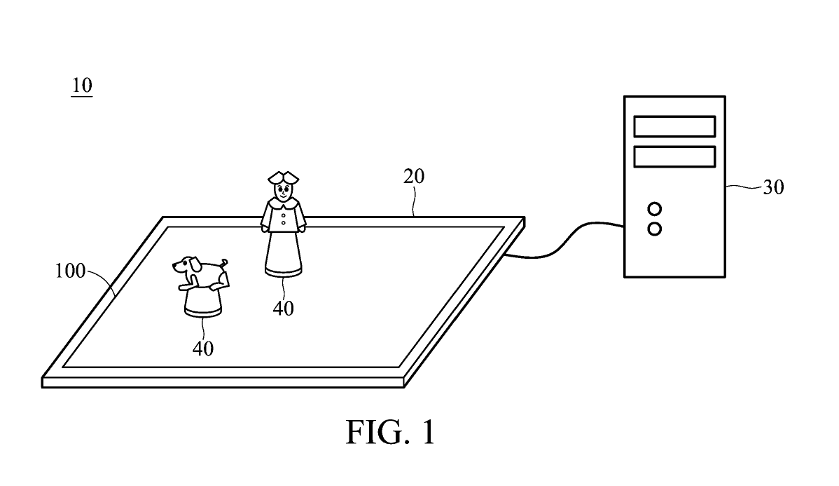

FIG. 1 is a schematic diagram illustrating an embodiment of a game system 10 of the invention. As shown in FIG. 1, the game system 10 comprises a game board 20 and a computer system 30 (e.g. a personal computer), wherein multiple objects 40 are located on the game board 20 and each of the objects 40 has an identification data such as an identification code, each of said objects capable of transmitting an identification signal including the identification code wirelessly to identify itself. For example, each object 40 may be a RFID tag that has a different identification code, which may be transmitted by a radio frequency technique for identification, but it is not limited thereto. In one embodiment, the game system 10 may transmit an initiating signal to different objects 40 and when the initiating signal has been received, each object 40 may reply an identification signal that works in a multiple objects environment, such as a time delay transmission, a frequency drift transmission or a pulse width modulation transmission thereto, allowing a location method of the invention to identify positions of each object based on identification of which object sending the replied identification signal. The initiating signal may be, for example, a signal for requesting or enabling a specific object 40 such that said object 40 is capable of providing an identification signal corresponding thereto. In one embodiment, the initiating signal may also provide energy to the object 40.

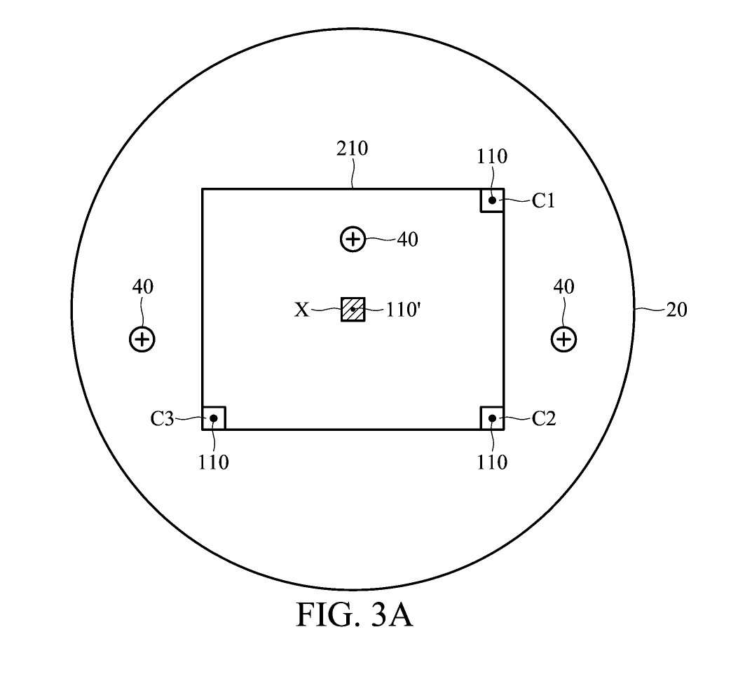

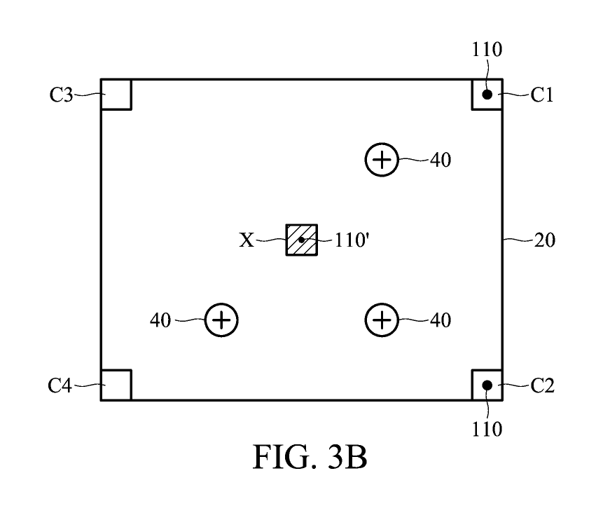

A location apparatus 100 may be configured on the game board 20 for determining a position of each object that is located on the game board 20. The game board 20 is coupled to the computer system 30 such that the computer system 30 may perform subsequent analysis and calculations according to an identification data obtained and/or a position determined by the location apparatus 100. It is to be noted that the game board 20 may be boards with any shapes, such as a square board, a rectangular board (as shown in FIG. 3B) or a circular board (as shown in FIG. 3A) depend on design requirement.

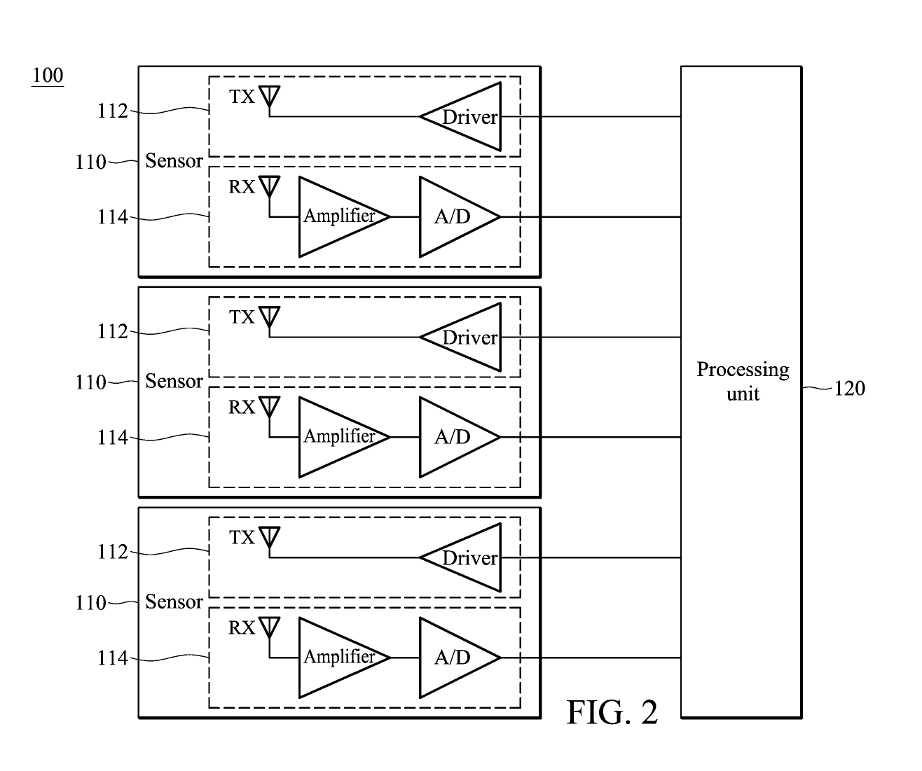

FIG. 2 is a schematic diagram illustrating an embodiment of a location apparatus 100 of the invention. As shown in FIG. 2, the location apparatus 100 comprises multiple sensors 110 and a processing unit 120, wherein the sensors 110 are coupled to the processing unit 120 and which are separately positioned at different positions on the board. In this embodiment, each sensor 110 may further have a transmission circuit 112 and a receiving circuit 114. The transmission circuit 112 may further comprise a transmission antenna TX and a driver for transmitting signals to the object 40 by the transmission antenna TX. The receiving circuit 114 may further comprise a receiving antenna RX, an amplifier and an analog-to-digital (A/D) converter for receiving a signal sent by the object 40 via the receiving antenna RX, amplifying and digitalizing the received signal via the amplifier and the A/D converter, and outputting the digitalized signal to the processing unit 120. In some embodiments, the receiving antenna RX and the transmission antenna TX may utilize the same one antenna. Note that, signal sent by the object 40 may generate a corresponding signal strength for the signal received by each receiving antenna RX so that the processing unit 120 may determine distances between the object 40 and each of the receiving antennas RX according to the signal strengths of the received signals so as to determine a position of the object 40 on the board 20. The processing unit 120 may collect signals received by any three of the sensors 110 and determine the position of the object 40 on the board 20 according to the signal strengths which are corresponding to the received signals. Therefore, only at least three sensors may be configured on fixed positions of the game board 20 and a relative position of a specific object 40 among the objects 40 located on the board 20 may be determined accordingly.

It is to be noted that the amount of the sensors 110 configured on the game board 20 may be adjusted according to the shape of the game board. For example, when the game board 20 is a square board or a rectangular board, with properly position configuration, only at least two sensors may need to be configured on fixed positions of the game board 20 to determine a relative position of a specific object 40 on the board 20 accordingly.

FIG. 3A is a schematic diagram illustrating an embodiment of a game board 20 of the invention. As shown in FIG. 3A, the game board 20 is a circular board having a specific shape region 210 (such as a square or a rectangular region) and three sensors 110 are separately positioned at positions C1, C2 and C3 for performing wireless communication with each object 40. A calibration point X that is positioned at a specific known position of the game board 20 may further be configured, wherein a calibration device 110′ may be configured under the calibration point X to provide a calibration signal. When booting, the processing unit 120 may calculate a measurement error for each sensor 110 by using the signal strengths of the signals sent by the calibration device 110′ to obtain calibration signals that represent differences (error values) of each of the sensors 110. The processing unit 120 may then utilize the data of the calibration process to perform an error adjustment or compensation for all of the sensors 110 according to the calibrated measurement errors obtained by each of the sensors 110. For example, as shown in FIG. 3A, the calibration point is positioned at the center of the circular board, i.e. the specific known reference position is the center of the game board 20.

FIG. 3B is a schematic diagram illustrating another embodiment of a game board 20 of the invention. As shown in FIG. 3B, the game board 20 is a square board or a rectangular board and at least two of the sensors 110 are separately positioned at the adjacent corners C1 and C2 (or C3 and C4) of the square board or the rectangular board.

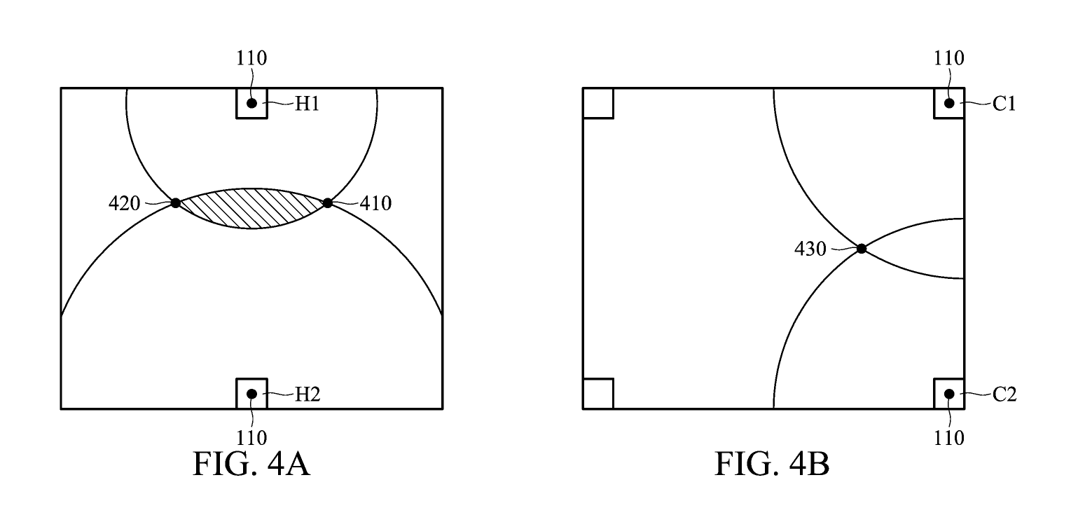

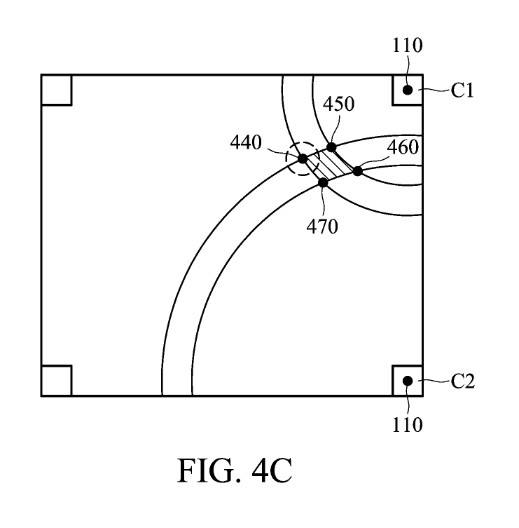

Because two sensors 110 are separately positioned at the adjacent corners of the square board or the rectangular board, only one position measurement value should be obtained after the location method is performed to the same object 40, thereby quickly determining the position of that object. Description of the detailed principle is as follows with referring to FIGS. 4A and 4B.

It is to be understood that, for brevity, location and calibration methods for one object is only discussed in the following embodiments, other objects on the game board may be located and error adjusted or compensated by the same manner.

FIG. 4A is a schematic diagram illustrating an embodiment of a locating result for two sensors that are not positioned at the adjacent corners of the invention. FIG. 4B is a schematic diagram illustrating an embodiment of a locating result for two sensors positioned at the corners of the invention. As shown in FIG. 4A, if the two sensors 110 are positioned at positions H1 and H2 separately, two possible position measurement values 410 and 420 estimated according to signal strengths of the signals that are sent from the object 40 to the two sensors 110 may be obtained, and thus further process will be performed in order to estimate actual position of the object 40. If the two sensors 110 are positioned at positions that are the adjacent corners separately, as shown in FIG. 4B, regardless the error, only one possible position measurement value 430 may be obtained so that the relative position of the object 40 may be determined quickly.

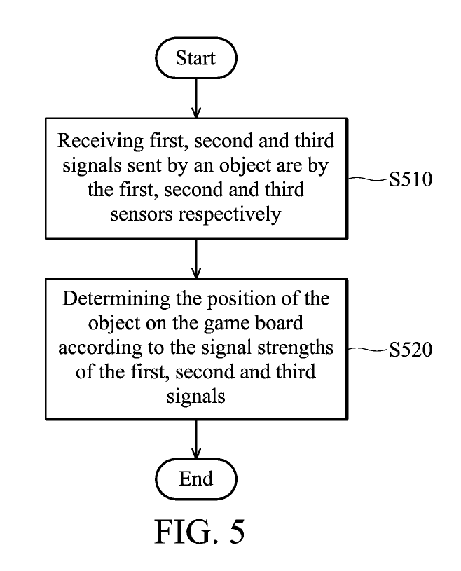

FIG. 5 is a flowchart of an embodiment of a location method of the invention. Referring together to FIG. 2, it is assumed that at least first, second and third sensors are configured on the location apparatus 100. The location method is capable of performing by the processing unit 120. As shown in FIG. 5, in step S510, first, second and third signals sent by an object 40 are first received by the first, second and third sensors respectively, wherein each of the signals has a signal strength. Note that the first, second and third sensors may respectively send an initiating signal to the object 40, and when the initiating signals have been received by the object 40, the object 40 may reply a reply signal with an identification data to the first, second and third sensors respectively. Since distances between the first, second and third sensors and the object 40 are different, signal strengths received by the first, second and third sensors are also different. Thus, in step S520, the processing unit 120 may find out possible position measurement values and then perform a calculation to determine the position of the object 40 on the game board 20 according to the signal strengths of the first, second and third signals.

Similarly, if the game board 20 is the square board or the rectangular board shown in FIG. 3B, as above-mentioned, the two sensors may be positioned at the adjacent corners of the board and the location method may be applied to determine the position of the object 40 on the game board 20 according to the signal strengths of the first and second signals received.

Generally, energy that is generated by the signal replied by the object 40 depends on a distance between the object 40 and the sensor 110. When this distance is too long, the received energy that is generated by the signal replied by the object 40 becomes relatively too low, so the position measurement may be erroneous. Alternately, the received signal may be lost or too difficulty to be detected.

To solve the aforementioned problem, in one embodiment, the location system further provides a common energizer for transmitting a high power initiating signal to each object such that each of the objects distributed in different positions may transmit the identification signal with a fixed voltage level.

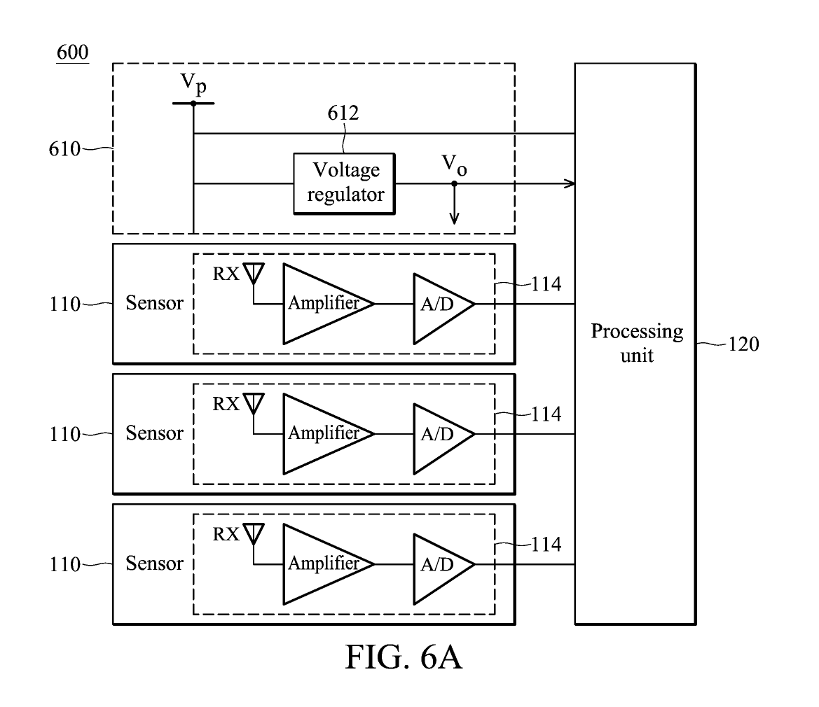

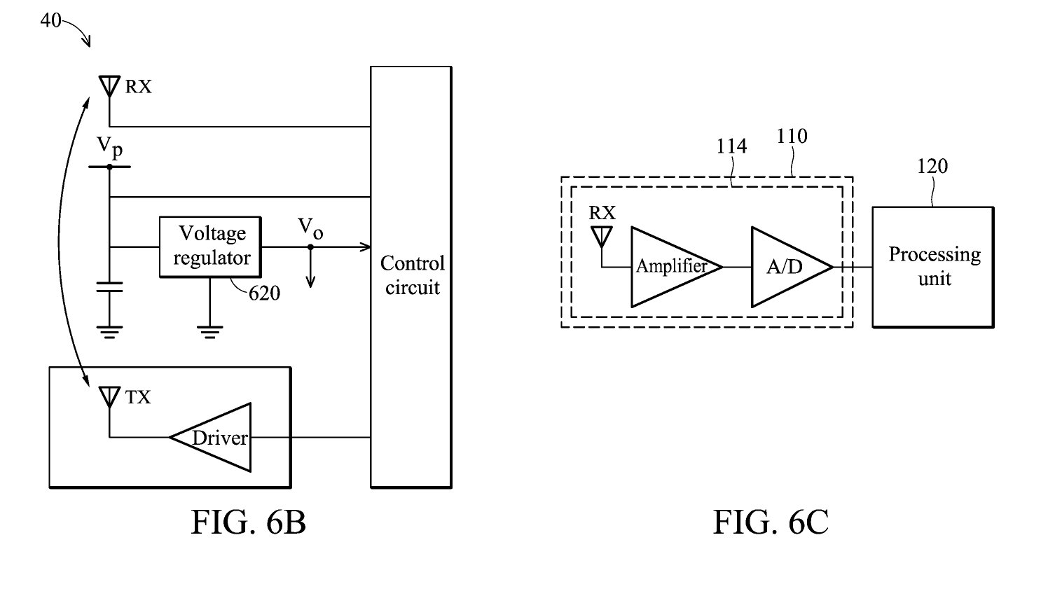

FIG. 6A is a schematic diagram illustrating another embodiment of a location apparatus 600 of the invention. Referring to FIG. 2, the structure of the location apparatus 600 is similar to that of the location apparatus 100 except that the location apparatus 600 further utilizes a common energizer (not shown), wherein the common energizer may be located at any position on the game board and may generate an energy that exceeds a predetermined sufficient energy required for each object (e.g. a voltage V_{P}), no matter where the object is positioned on the board. Additional voltage stabilizing circuit 610 may be added to the sensor end of the location apparatus 600. As shown in FIG. 6A, the voltage stabilizing circuit 610 may further comprise a voltage regulator 612 for providing same stabilized voltages to all of the sensors 110, including all of the A/D converters, so as to reduce the error at the sensor end.

For example, referring to FIGS. 6A and 6B, when the location apparatus 600 in FIG. 6A requires to transmit signals to the objects 40 in FIG. 6B, the common energizer will generate a large enough energy V_{P} to the objects 40 such that each object 40 will receive an energy over that it required and the received energy will then adjusted to a fixed voltage level V₀ via the voltage regulator 620. By doing so, each object 40 may then transmit signals with the fixed voltage level V₀ via the transmission antenna TX therein. Therefore, regardless how far the distance between the object 40 and the sensor 110 is, signals sent by each object will be transmitted with a fixed voltage so that energy differences between signals sent by each of the objects 40 can be prevented, thereby reducing the tolerance and deviation caused by peer-to-peer signal deviation between the objects 40 and the sensor 110 and acquiring a better reply energy.

In addition, the common energizer may further comprise a transmission antenna and the common energizer may handle and perform all transmission operations so each sensor 110 within the location apparatus 600 may remove the transmission circuit 112 and keeps only the receiving circuit 114 therein as shown in FIG. 6C. FIG. 6C is a schematic diagram illustrating an embodiment of a sensor circuit of the invention. It is to be noted that the sensor 110 shown in FIG. 6C comprises the receiving circuit 114 only.

In other words, compared with a conventional sensor circuit design that has a receiving circuit and a transmission circuit (e.g. the sensor 110 shown in FIG. 2), each sensor may keep only the receiving circuit by using a design that has a common transmission end and a common energizer according to the invention, thus simplifying the circuit complexity of the sensor, lowing the product cost and reducing the signal deviations.

Furthermore, in some embodiments, when two objects are placed close to each other, signal strength received from one object may become too close to that received from the other one such that the location apparatus may not efficiently identify the resolution of the positions therebetween. Thus, in one embodiment, the location apparatus of the invention further provides a structure that ensures a minimum distance between two adjacent objects 40 according to a predetermined condition, wherein the predetermined condition represents that the minimum distance 2L between each two adjacent objects is larger than or equal to the smallest error distance 2R, wherein 2R is the minimum error distance for representing the minimum distance that can be tolerated between two corresponding objects taking in account of the measurement error value or other conditions tolerated between two objects. Note that the minimum error distance is defined as the minimum distance such that the two adjacent objects can be recognized therebetween when error or tolerance is being considered. Conventionally, the value of the 2R can be determined by repeatedly analyzing the results of the measurement experiment.

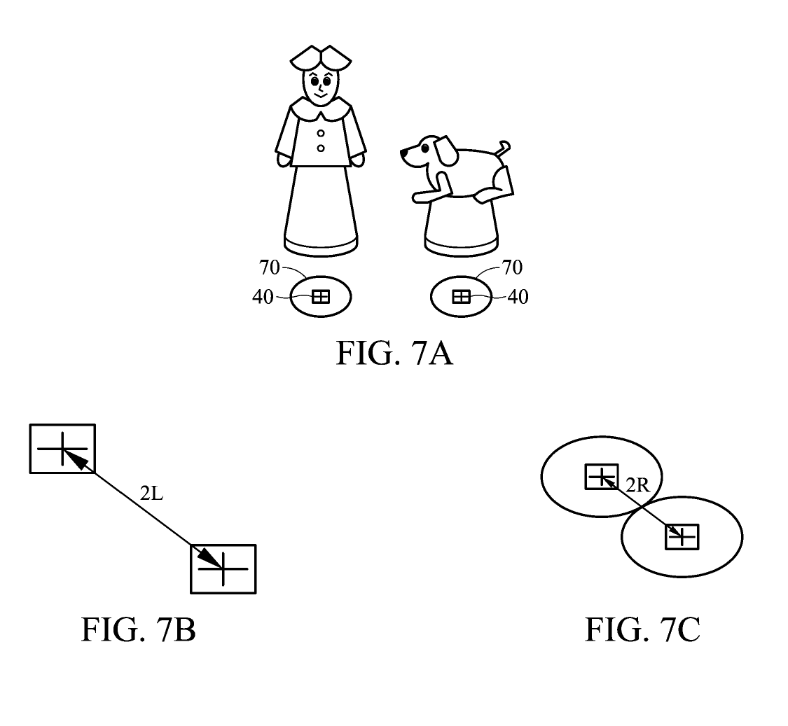

FIG. 7A is a schematic diagram illustrating an embodiment of an object configuration of the invention. As shown in FIG. 7A, the object 40 is being placed within a doll that has a round shape casing 70 and it is assumed that the radius of round shape casing 70 is set to be R. FIGS. 7B and 7C are schematic diagrams illustrating embodiments of object distances of the invention. As shown in FIG. 7B, if no special control process has been performed, a position distance between two adjacent objects is defined as 2L. When the distance 2L between the two objects as shown in FIG. 7B is less than 2R, we cannot distinguished between two objects. Please refer again to FIG. 7C, in this embodiment, the object 40 has been placed within a round shape casing whose radius is R and thus the distance between the two objects must be 2R (i.e. equal to the diameter of the round shape casing) or more than the 2R. Therefore, if a condition that 2L is always larger than or equal to 2R can be achieved, i.e. the diameter of the round shape casing is larger than or equal to the minimum distance 2R which is the minimum distance between two corresponding objects that can be tolerated, taking into the account of component tolerance and measurement error values.

Further, in some embodiment, due to component tolerance, signal noise and parametric variations, more than one position measurement values may be obtained after the locating process has been performed. As a result, the actual position of the object cannot be determined correctly.

It is to be noted that, in the following embodiments, locating results for two or four sensors being positioned at the corners of the rectangular board are used as an example for illustration to resolve the above mentioned problems, but the invention is not limited thereto.

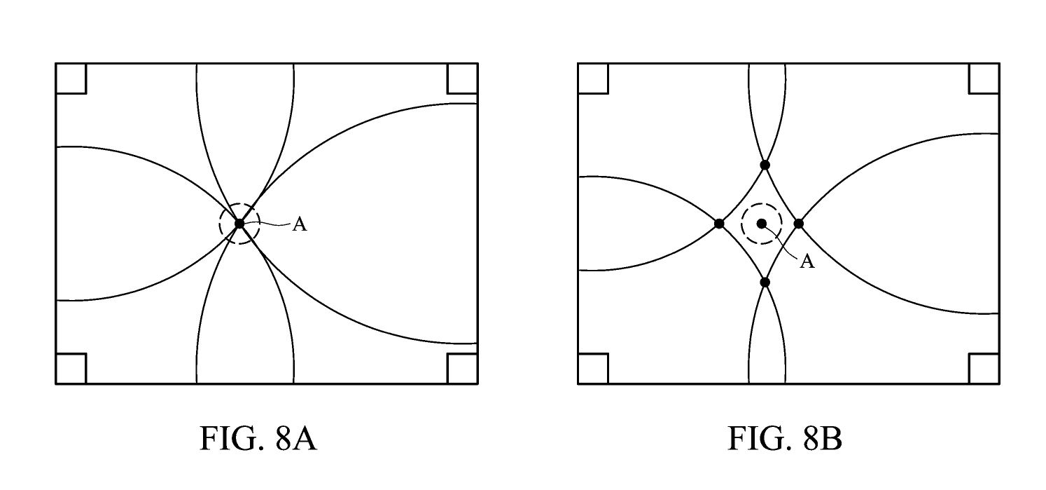

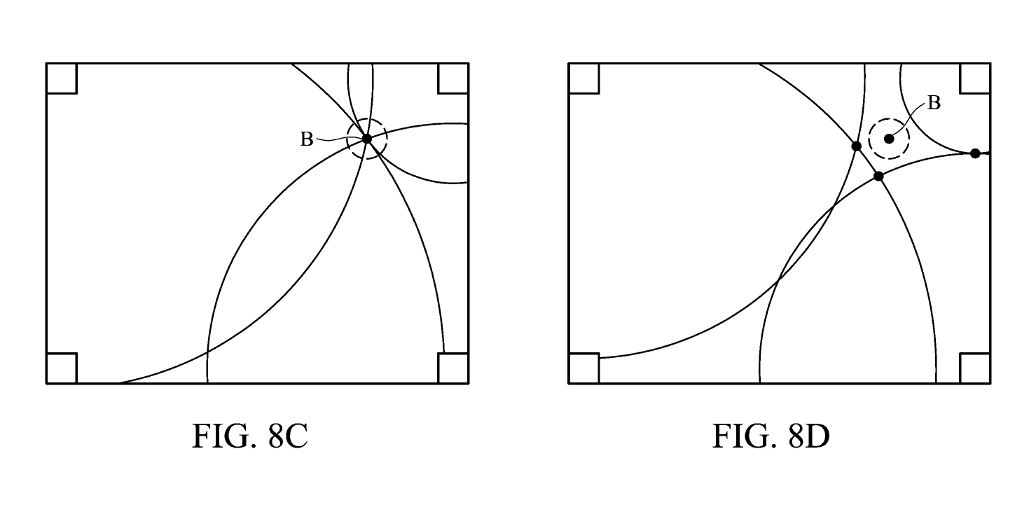

FIG. 4C is a schematic diagram illustrating an embodiment of a locating result for two sensors positioned at the corners of the invention in which there is an error occurred. Please refer together to FIG. 4B and FIG. 4C. If no error occurs, ideally, only one position measurement value (e.g. point 430 shown in FIG. 4B) should be obtained after the locating process has been performed. However, four possible position measurement values (e.g. points 440-470 shown in FIG. 4B) may be obtained after the locating process has been performed if maximum positive and negative error variations of the signal strengths are accounted. In this case, the actual position of the object may be any point in the shaded area formed by the four position measurement values (e.g. a dotted line area shown in FIG. 4C). Please further refer to FIGS. 8A to 8D.

FIGS. 8A-8D are schematic diagrams illustrating embodiments of locating results for four sensors positioned at the corners of the invention, wherein each point shown in figures represents a position measurement value. As shown in FIGS. 8A and 8C, when the object is positioned at the position A or position B and no error occurs, ideally, only one position measurement value should be obtained after the locating process has been performed. However, if there is any errors, four possible position measurement values corresponding to the position A (as shown in FIG. 8B) or three possible position measurement values corresponding to the position A (as shown in FIG. 8D) may be obtained after the locating process has been performed. In FIG. 8B, each of the four possible positions measured is obtained by comparing the signal strength received by two sensors located at two adjacent corners of the game board. Since there are four sensors located at the four corners of the game board of FIG. 8B, four different position readings may be obtained when significant component tolerance or measurement resolution errors are accounted. FIG. 8D illustrated a condition when only three possible measured positions can be obtained.

In this case, the actual position of the object may be at a position in between the several position measurement values. The actual position of the object cannot be obtained directly from the signal measurements provided by each pair of adjacent sensors, so that further calculations are required in order to obtain the actual position of the object.

Therefore, in some embodiments, the location apparatus of the invention may further required to perform a calculation procedure to correct the measurement errors.

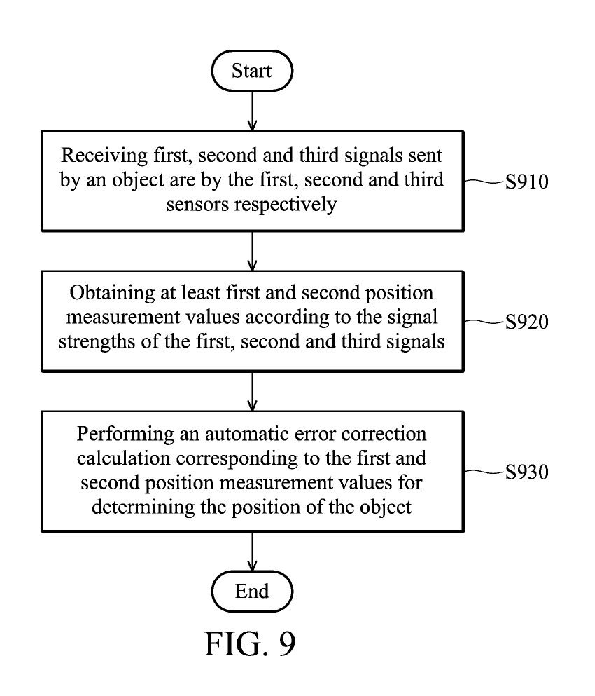

FIG. 9 is a flowchart of an embodiment of a measurement error correction method of the invention for computing the position measurement values for multiple objects located on a game board. In this embodiment, it is assumed that the location apparatus 100 shown in FIG. 2 and the game board shown in FIG. 3A are utilized as an example, wherein each object may transmit an identification code wirelessly for identification and at least first, second and third sensors are configured on the location apparatus 100. The measurement error correction method is capable of performing by the processing unit 120.

As shown in FIG. 9, in step S910, first, second and third signals sent by an object 40 are first received by the first, second and third sensors respectively, wherein each of the signals has a signal strength. Note that the first, second and third sensors may respectively send an initiating signal to the object 40 or a common energizer may transmit an initiating signal to the object 40 such that the first, second and third sensors can obtain the first, second and third signals respectively.

Thereafter, in step S920, the processing unit 120 obtains at least first and second position measurement values according to the signal strengths of the first, second and third signals respectively. As more than two position measurement values have been obtained, which indicates that there may be some errors occur, a measurement error correction procedure is required to be performed. Thus, in step S930, the processing unit 120 performs an automatic error correction operation corresponding to the first and second position measurement values so as to determine the position of the object. For example, in one embodiment, the step of performing the automatic error correction operation corresponding to the first and the second signal strengths or position measurement values may be performed by utilizing a calibration point positioned at a specific position (e.g. the center of the game board) to perform an error adjustment calculation with the first and the second signal strengths or position measurement values to determine a corresponding error adjustment value of each of the sensors. Note that, when booting, the processing unit 120 may perform an auto tolerance calibration with the calibration point to obtain a measurement error for each sensor and then an error cancellation calculation process can be carried out utilizing the measurement error for each sensor, to converge the first and second position measurement values into a single position of the object.

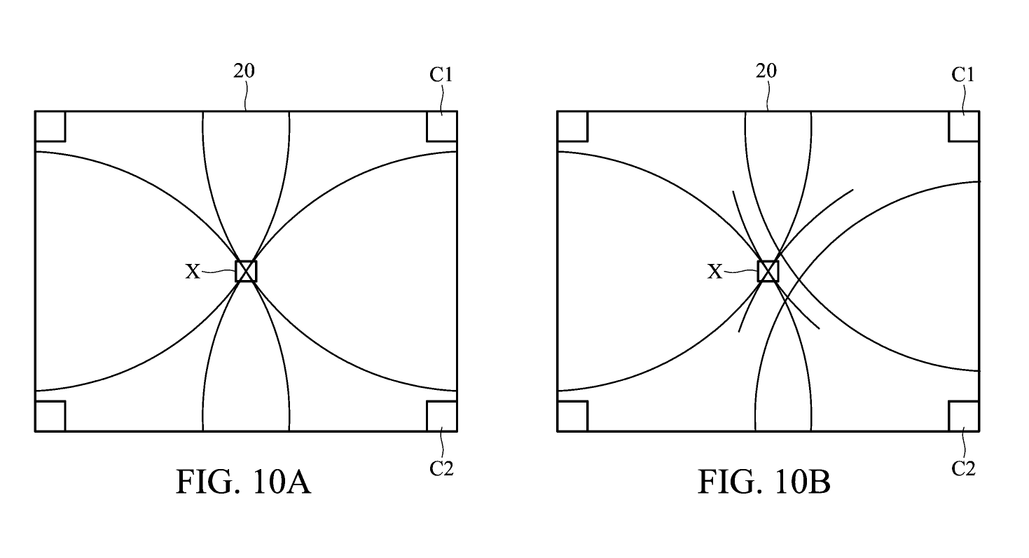

FIGS. 10A and 10B are diagrams illustrating embodiments of auto tolerance calibration results calibrated by using a calibration point of the invention. As shown in FIG. 10A, as the calibration point X locates at the center, or a known position of the game board 20, if no measurement errors are occurred among all sensors, only one position measurement value will be obtained after the auto tolerance calibration procedure has been performed. However, if there is any tolerance or measurement errors happened at some sensors, such as sensors located at points C1 and C2 shown in FIG. 10B, multiple positions readings can be obtained by the different cross over points of the plotting of FIG. 10B. By knowing the exaction location X of the calibration point, corresponding error correction value for each sensor can be calculated during the power up tolerance calibration process. These error correction values can be automatically utilized to compute with the signal strength of the received signals for those sensors so as to obtain one final position of an object positioned on the board 20.

In another embodiment, the step of performing the automatic tolerance calibration and measurement error adjustment or correction process can be achieved by utilizing a successive approximation method to gradually reduce a search range of all possible measurement values such that a final result approaching to a single point can be obtained; and that single point is then set to be the final position of the object.

In another embodiment, the step of performing the automatic tolerance calibration operation and measurement error correction process corresponding to the first and second signal strengths or position measurement values can be achieved by the support of an interpolation operation to the first and the second signal strengths or position measurement values and then utilizing the result of the interpolation operation to determine the position of the object.

In another embodiment, a characteristic curve for distances and signal strengths of each of the sensors can be measured in advance and then the characteristic curve can be used to generate a lookup table. Thereafter, the automatic tolerance calibration operation and measurement error correction process can be performed by comparing the different set of measured position values with the lookup table, so as to determine the final position of the object.

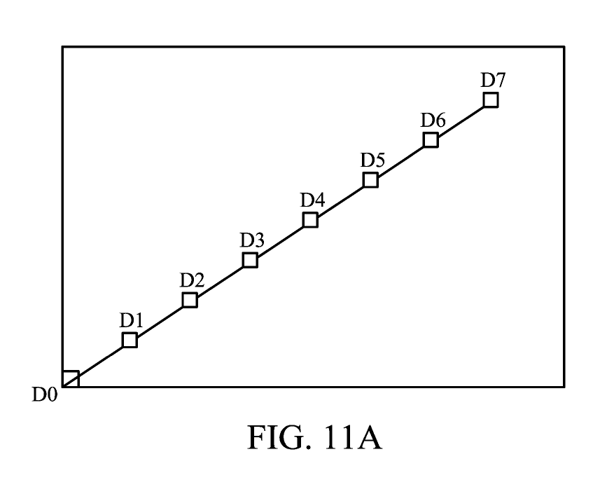

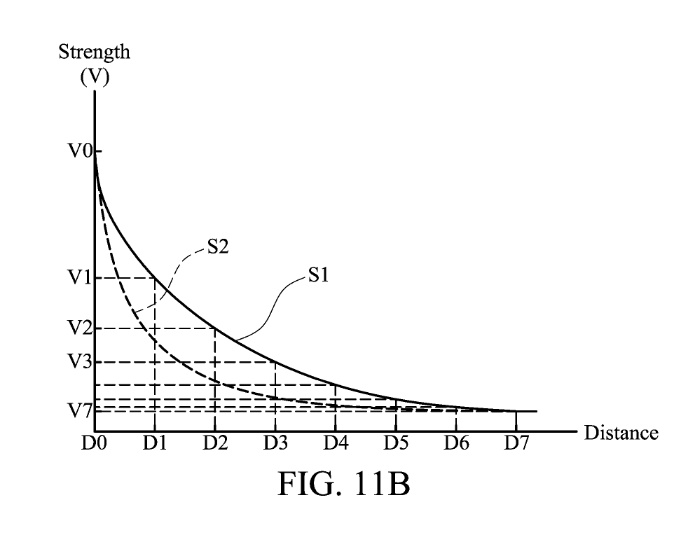

FIG. 11A is a plotting illustrating an embodiment of a characteristic curve measurement method of the invention. In this embodiment, it is assumed that the sensor is located at the left-down corner D0 and a target object is sequentially moving to the position D7 following an order from position D0 to D7 wherein a signal strength of the signal received by the target object in each of the positions D0 to D7 will be recorded in a lookup table T as shown in FIG. 11B. That is, the lookup table T may record an error correction relationship between different distances and signal strengths. After all of the measurements have been done, the characteristic curve for distances and signal strengths of each of the sensors can be derived from content of the look up table T.

FIG. 11B is a diagram illustrating a characteristic curve plotting measured by using the characteristic curve measurement method of FIG. 11A. In FIG. 11B, curve S1 represents a characteristic curve for a sensor that is only used for receiving signals (Referring to FIG. 6A) while curve S2 represents a characteristic curve for a sensor that is both used for receiving and transmitting signals (Referring to FIG. 2). It can be observed from the curve S1 that a corresponding distance is set to be D1 if the signal strength of the signal received by the sensor is equal to V1 while a corresponding distance is set to be D3 if the signal strength of the signal received by the sensor is equal to V3. Therefore, the error adjustment calculation can be achieved by simply comparing measured data with this characteristic curve. In addition, when comparing the curve S1 to the curve S2, it can also be found that utilizing the hardware configuration of the FIG. 6A (i.e. one common transmission unit and multiple sensors, each sensor having only the receiving circuit) can efficiently eliminate the non-linearity of the characteristic curve and efficiently improve measurement accuracy.

In summary, according to the location apparatus and location method thereof of the invention, by locating a specific number of sensors, wherein the position for each sensor is known, on a specific area (e.g. a game board), a corresponding identity and position for each of multiple objects located on the game board can be identified and determined. Particularly, for game boards with specific shapes such as a square game board or a rectangular board, sensors may be further located at the adjacent corners of the boards to reduce hardware design complexity. Additionally, several simplification manners for hardware designs are provided in the invention so as to reduce the required hardware cost efficiently. Furthermore, when considering errors caused by the measurement or circuits tolerance therein itself, the measurement error correction or tolerance calibration method of the invention can be applied to reduce the impact of the errors and thus location accuracy can be improved. The term error correction is defined to include any process directed to provide the closest actual readings of data measurements and computations; accordingly this term is defined to include the process of data value adjustment, data error compensation as well as calibration processes provided to resolve errors due to component and facility tolerances or system errors.

Location apparatuses and location methods and location systems using the same, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of examples and in terms of preferred embodiments, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A location method for determining the positions of a plurality of objects located on a game board, wherein each of said objects transmits an identification signal wirelessly, comprising:
providing at least a first sensor, a second sensor and a third sensor;
receiving a first, a second and a third identification signals sent by one of said objects, each of said identification signals received by each sensor having a signal strength; and
determining a position of said object on said game board according to said signal strengths of said identification signals received by said first, second and third sensors,
wherein said first, second and third sensors are separately located at different fixed positions of said game board.

2. The location method of claim 1, wherein said game board further comprises a square region or a rectangular region, and two of said sensors are positioned at said adjacent corners of said square region or rectangular region.

3. The location method of claim 1, further comprising:
providing a calibration point positioned at a specific position of said game board for performing measurement error correction or tolerance calibration for each sensor, wherein said calibration point provides a calibration signal.

4. The location method of claim 3, wherein said specific position is the center of said game board.

5. The location method of claim 1, further comprising:
separately transmitting an initiating signal from each of said first, second and third sensors to an object and for said object to provide an identification signal corresponding to each of said initiating signals received.

6. The location method of claim 1, further comprising:
transmitting an initiating signal from a common energizer for providing energy to said objects and for each of said objects to transmit an identification signal representing the identity and position of said object.

7. The location method of claim 6, further comprising:
providing a voltage regulator for each of said objects such that each object transmits an identification signal at a fixed predetermined voltage level.

8. The location method of claim 1, further comprising:
positioning each of said objects with a casing, which is configured to control the minimum separation distance between two objects located on said game board, wherein said minimum separation distance is larger than or equal to the smallest distance between two objects that can be resolved by said game board.

9. The location method of claim 1, further comprising:
providing each of said objects a time delay transmission circuit, a frequency drifting circuit, or a pulse width modulation transmission circuit so as for said game board to identify and measure the positions of multiple objects coexist on said game board.

10. The location method of claim 1, wherein each of said objects comprises a different RFID tag.

11. A location system configured on a board, wherein
said board comprises a rectangular region or a square region;
said location system is provided for determining the positions of a plurality of objects located on said rectangular region or square region;
each of said objects is capable of transmitting an identification signal including an identification code wirelessly; and
said location system further comprises:
at least two sensors, wherein said two sensors are separately positioned at adjacent corners of said square region or rectangular region for separately receiving an identification signal from one of said objects, each of said identification signals received by each sensor having a signal strength; and
a processing unit coupled to said two sensors, determining a position of said object on said game board according to the signal strengths of said identification signals received by said sensors.

12. The location system of claim 11, further comprising a calibration point positioned at a specific predetermined position of said square region or rectangular region for providing a calibration signal.

13. The location system of claim 12, wherein said specific predetermine position is the center of said square region or rectangular region.

14. The location system of claim 12, wherein said location system is further configured for providing a calibration signal to perform a measurement error correction process and for determining the positions of said objects.

15. The location system of claim 11, wherein each of said sensors separately comprises a transmitting circuit and a receiving circuit; said transmitting circuit is configured for transmitting an initiating signal to said object and for said object to transmit an identification signal to be received by said receiving circuit of said sensor.

16. The location system of claim 11, further comprising a common energizer for providing energy to each of said objects; and for each of said objects to transmit an identification signal with said energy received.

17. The location system of claim 11, wherein each of said objects further comprises a voltage regulator for transmitting an identification signal at a fixed predetermined voltage level.

18. The location system of claim 11, wherein said location system further comprises a structure configured to ensure that the distance between two adjacent objects is always longer than or equal to the smallest distance between two objects that can be resolved by said location system.

19. The location system of claim 11 further configured to identify said positions of multiple objects located on said board by utilizing a time delay, a frequency drifting or a pulse width modulation transmission.

20. The location system of claim 11, wherein each of said objects comprises a RFID tag.

21. A measurement error correction method for use in a location apparatus provided to measure the location of an object, wherein said object is configured to transmit an identification signal wirelessly; said location apparatus comprises at least first and second sensors separately positioned at different fixed positions of a game board, said error correction method comprising:
separately receiving a first and a second identification signals by said first and second sensors;
obtaining a first position value of said object represented by the signal strengths of said first and second identification signals; and
performing an automatic error correction operation corresponding to said first and said second signal strengths and/or said first position value to determine a position of said object located on said game board.

22. The measurement error correction method of claim 21, wherein said game board further comprises a calibration point located at a specific predetermined position of said game board, and said automatic error correction operation comprises a step to compute the signals received by said first and second sensors from said calibration point.

23. The measurement error correction method of claim 22, further comprises:
a step utilizing said calibration point to obtain an error adjustment value corresponding to each of said sensors; and
utilizing the corresponding error adjustment value of each of said sensors, the signal strengths of said first and second identification signals, and/or said position value to perform said automatic error correction operation.

24. The measurement error correction method of claim 23, wherein said specific predetermined position is the center of said game board.

25. The measurement error correction method of claim 21 further comprising a third sensor for providing a second position value with the signal received by said first sensor; wherein said automatic error correction operation comprises a successive approximation operation to gradually reduce a search range provided by said first and second position values.

26. The measurement error correction method of claim 21 further comprising a third sensor for providing a second position value with the signal received by said first sensor; wherein said automatic error compensation operation comprises an interpolation operation to compute said signal strengths and/or position values.

27. The measurement error correction method of claim 21, wherein said automatic error correction operation is performed by comparing a signal strength or a position value with a lookup table; wherein said lookup table represents the distances and signal strengths characteristics of a sensor.

28. The measurement error correction method of claim 21, wherein said game board further comprises a square region or rectangular region, and two of said sensors are positioned at the adjacent corners of said square region or rectangular region.

29. The measurement error correction method of claim 21 further comprising a third sensor for providing a second position value with the signal received by said first sensor; said error correction method further comprising:
a step to separately transmit an initiating signal to an object by each of said first, second and third sensors for said object to transmit an identification signal each time an initiating signal is received.

30. The measurement error correction method of claim 21, further comprising:
a step for a common energizer to transmit an initiating signal to multiple objects located on said game board; and for providing energy to said objects such that each of said objects transmits an identification signal when an initiating signal is received.

31. The measurement error correction method of claim 21, further comprising:
a step to provide a voltage regulator to each of said objects and for each of said objects to transmit an identification signal at a fixed voltage level.

32. A location system configured on a game board for determining the positions of a plurality of objects located on said game board, wherein each of said objects is capable of transmitting an identification signal including an identification code wirelessly for identification, said system comprising at least three receiving devices and at least one of the following characteristics:
(1) said game board comprises a calibration point positioned at a specific predetermined position for providing a calibration signal;
(2) said location system comprises a common energizer and a plurality of receiving antennas, wherein each of said receiving devices has a corresponding receiving antenna; said location system further comprises a common energizer configured for providing an initiating signal and energy to said objects.
(3) each of said objects comprises a voltage regulator such that each object transmits an identification signal at a fixed voltage level; and/or
(4) said location system is configured to ensure that a distance between two adjacent objects is always longer or equal to a minimum distance that can be resolved by said location system.

33. The location system of claim 32, wherein said calibration point is positioned at the center of said game board.

34. The location system of claim 32, wherein said location system further performs a tolerance calibration operation according to the calibration signal provided by said calibration point and for computing the measurement errors corresponding to each of said receiving devices.

35. A machine-readable storage medium comprising a computer program, which, when executed, causes a location device to perform a location method for determining the positions of a plurality of objects located on a game board, wherein each of said objects is configured to transmit an identification signal wirelessly for identification and at least one first, one second and one third sensors, each separately positioned at different fixed locations of said game board, and said location method comprising:
each time when an object transmits an identification signal, obtaining a first, a second and a third identification signals received by said first, said second and said third sensors, wherein each of said received identification signals has a signal strength; and
determining the positions of said objects on said game board according to the signal strengths of said identification signals received.
